(19) United States
(12) Patent Application Publication
(10) Pub. No.: US 2010/0153116 A1
(43) Pub. Date: Jun. 17, 2010

(54) METHOD FOR STORING AND RETRIEVING VOICE FONTS

(76) Inventors: Zsolt Szalai, Tourrettes-sur-Loup (FR); Philipe Bazot, Vence (FR); Bernard Pucci, Cagnes Sur Mer (FR); Joel Viale, Vence (FR)

Correspondence Address: HOFFMAN WARNICK LLC, 75 STATE ST, 14 FL, ALBANY, NY, 12207, US

(21) Appl. No.: 12/368,352

(22) Filed: Feb. 10, 2009

(30) Foreign Application Priority Data
Dec. 12, 2008 (FR) 08305913.9

(51) Int. Cl. G10L 13/08; G06F 15/16

(52) U.S. Cl. 704/260; 709/206; 704/E13.001

(57) ABSTRACT

The present invention is a system for storing text-to-speech files which includes a means for storing a plurality of voice fonts wherein each voice font has associated therewith a universal voice identifier (UVI). The invention includes delivering a voice font to a receiver of a message containing text wherein the message contains the UVI and the receiver requests the voice font associated with the UVI from the means for storing.

### CROSS REFERENCE TO RELATED APPLICATIONS

This application relates to commonly assigned copending application Ser. No. ______ (Docket No. FR92008161US1), entitled METHOD FOR DYNAMIC LEARNING OF INDIVIDUAL VOICE PATTERNS filed simultaneously herewith. This application claims priority to French application number 08305913.9, filed Dec. 12, 2008.

### FIELD OF THE INVENTION

The present invention relates to the field of speech recognition and more particularly to identifying or tagging a personal voice font (PVF) for delivery to authorized users.

### BACKGROUND OF THE INVENTION

Text-to-speech (TTS) is a technology that converts computerized text into synthetic speech. The speech is produced in a voice that has predetermined characteristics, such as voice sound, tone, accent and inflection. These voice characteristics are embodied in a voice font. A voice font is typically made up of a set of computer-encoded speech segments having phonetic qualities that correspond to phonetic units that may be encountered in text. When a portion of text is converted, speech segments are selected by mapping each phonetic unit to the corresponding speech segment. The selected speech segments are then concatenated and outputted audibly through a computer speaker.

TTS is becoming common in many environments. A TTS application can be used with virtually any text-based application to audibly present text. For example, a TTS application can work with an email application to essentially “read” a user's email to the user. A TTS application may also work in conjunction with a text messaging application to present typed text in audible form. Such uses of TTS technology are particularly relevant to user's who are blind, or who are otherwise visually impaired, for whom reading typed text is difficult or impossible.

In some TTS systems, the user can choose a voice font from a number of pre-generated voice fonts. The available voice fonts typically include a limited set of voice patterns that are unrelated to the author of the text. The voice fonts available in traditional TTS systems are unsatisfactory to many users. Such unknown voices are not readily recognizable by the user or the user's family or friends. Thus, because these voices are unknown to the typical receiver of the message, these voice fonts do not add as much value or are as meaningful to the receiver's listening experience as could otherwise be achieved. More generally, TTS participates in the evolution toward computer natural user interfaces.

When a sender of a document has created a personal voice font it is not of use to a receiver of the document. There is no adequate system that exists for storing and publishing individual voice patterns or voice fonts. Moreover, there is no adequate system for identifying and retrieving individual voice patterns to allow a voice belonging to a specific user to be used at the destination of the text to be read out.

The present invention provides a solution to these problems.

### SUMMARY OF THE INVENTION

In one aspect of the invention a storage and delivery system for personal voice font (PVF) files is described. It includes storing a plurality of voice fonts wherein each voice font has associated therewith a universal voice identifier (UVI) and can be retrieved using the UVI as a key. It further includes retrieving a voice font by a receiver of a message containing text wherein the message contains the UVI and the receiver requests the voice font associated with the UVI from storage. Finally text is converted to speech using the voice font associated with the UVI.

The present invention includes a method for converting text to speech which includes storing a plurality of voice fonts wherein each voice font has associated therewith a universal voice identifier (UVI) and can be retrieved using the UVI as a key. The invention further includes retrieving a voice font by a receiver of a message containing text wherein the message contains the UVI and converting text to speech of the message using the voice font associated with the UVI.

In another aspect of the invention a computer-readable medium having computer-executable instructions that, when executed, cause a computer to perform a process is disclosed. The process includes storing a plurality of voice fonts wherein each voice font has associated therewith a universal voice identifier (UVI) and can be retrieved using the UVI as a key. The invention further includes retrieving a voice font by a receiver of a message containing text wherein the message contains the UVI and converting text to speech of the message using the voice font associated with the UVI.

In a further aspect of the invention a method for for deploying a system for converting text to speech is disclosed. The method comprises providing a computer infrastructure being operable to store a plurality of voice fonts wherein each voice font has associated therewith a universal voice identifier (UVI), retrieve a voice font by a receiver of a message containing text wherein the message contains the UVI, and convert text to speech of the message using the voice font associated with the UVI.

### BRIEF DESCRIPTION OF THE SEVERAL VIEWS OF THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1 is a schematic diagram of publishing and retrieving a PVF in accordance with an embodiment of the present invention;

FIG. 2 is a schematic block diagram of the PVF storage and retrieval system in accordance with an embodiment of the present invention;

FIG. 3 is a schematic of an embodiment of the present invention in operation.

### DETAILED DESCRIPTION OF THE INVENTION

The present invention provides a storage system and delivery mechanism allowing a Personal Voice Font (PVF) to be used for reading out text at a user's computer, cell phone or other device.

A voice font is a digital representation of a voice pattern. A PVF characterizes the voice of one specific person. Presently, there are text to speech (TTS) systems with pre-defined voice fonts. Examples of such systems are Microsoft Office Tools and Navigation systems.

It is desirable that once a PVF is created, it can be made available for consumption by TTS functions for reading text items out with a particular person's personal voice pattern. Sharing of a PVF can be used in a wide variety of applications. The present invention transports or includes a UVI (Universal Voice Identifier) in the text document. Alternatively, a PVF can be invoked by manual selection of a UVI by the user.

TTS systems with pre-defined Voice patterns (examples: IBM VIA VOICE, MICROSOFT OFFICE PRODUCTS, various Instant Messaging systems, Navigation systems) are available today. However, in order to use a personalized voice pattern it is necessary to identify and access a PVF reliably. The present invention provides a Universal Voice Identifier (UVI) which is a unique identifier, which an individual person uses to identify his or her vocal signature. One example for the format of the UVI is [CountryCode][SocialSecurityID]. Additional attributes or extensions to the UVI include the age of the person, the year when the PVF was recorded, etc. Such a TTS system provides a UVI that reflects changes in a person's life.

The Personal Voice Font is a digital representation of a person's voice pattern. The PVF is uniquely referenced by the associated UVI of the individual. Each application or system that uses a PVF (to read text out with the actual voice of an individual), can use the UVI to search through a network and retrieve the corresponding voice font.

The present invention provides a Voice Naming Service or VNS. It is a distributed system (with an architecture similar to the DNS), available on a network, that stores, for each UVI, a reference (for example a URI) to the corresponding Personal Voice Font.

The system that stores the PVF informs the VNS of the existence and location of the PVF, referenced by the UVI. Whenever the location changes, the VNS must be updated with the new location. When a system needs to access a voice font, the system just interrogates the local VNS on the network, with the UVI as an input parameter. In response, the system gets a reference to where the PVF is physically stored. The PVF can be stored anywhere and by any system on the network. Examples of such networks are the Internet, a corporate Intranet or an LDAP network. The access to the PVF can be controlled to provide the appropriate level of security. The role of owner and manager of the voice pattern can be assigned directly to the single person or can be delegated to a global authority.

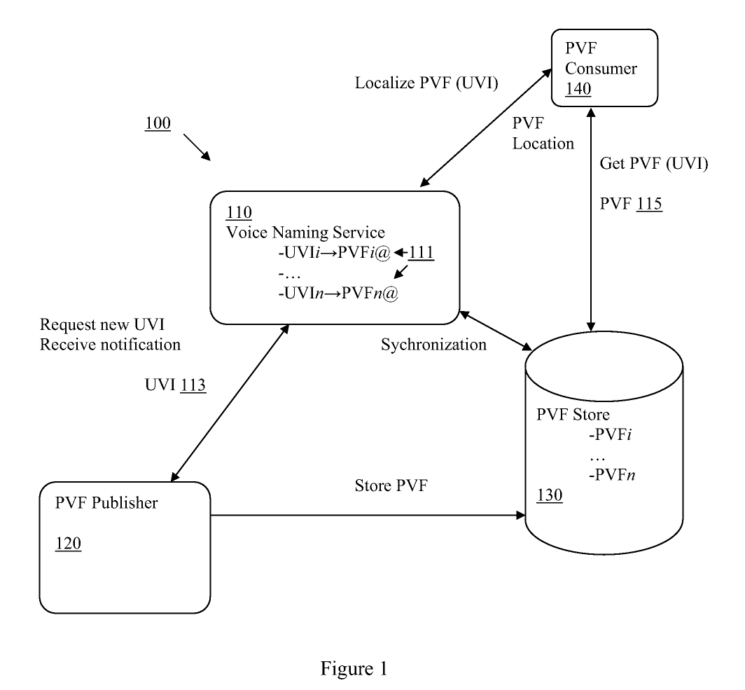

FIG. 1 shows a system 100 for publishing and retrieving a PVF. A voice naming service (VNS) shown as block 110 provides a service similar to the domain naming service (DNS) wherein unique identifiers 111 are provided for a registered PVF. The system begins when a user, represented by the PVF Publisher 120 block, wants to obtain a UVI 113 for his or her PVF. The PVF Publisher 120 interrogates the VNS 110 for a unique UVI. The PVF Publisher 120 receives back a UVI 113 for the user. There could be a fee associated with this service, raised by the VNS provider or by the PVF Publisher 120 in cases where this is provided as a service to end-users, or both. A PVF Store 130 stores the PVF 115 of the user. In a preferred embodiment of this invention, the PVF Publisher 120 communicates to the PVF Store 130 the UVI 113 that corresponds to the PVF to be stored. The PVF Store 130 maintains a UVI-PVF association locally. This allows the VNS 110 to dynamically acquire the PVF location for each UVI through an ongoing automatic synchronization mechanism with a plurality of distributed PVF stores 130.

In another embodiment, the PVF Store 130 remains unaware of the UVI and the PVF Publisher 120 needs to notify the VNS 110 of the location of the PVF. Once the PVF is stored in the PVF Store 130, and associated with a UVI in the VNS 110, a PVF Consumer 140 can fetch the PVF object from the PVF Store 130. For this, the PVF Consumer 140 queries the VNS 110 using a UVI as a key and receives the location address of the PVF in response. The PVF Consumer 140 then fetches the PVF from the location address. In an alternate embodiment, the functions of the VNS 110 can include fetching the PVF from the PVF Store 130. In that case, the VNS returns the actual PVF on an incoming request from the PVF Consumer 140.

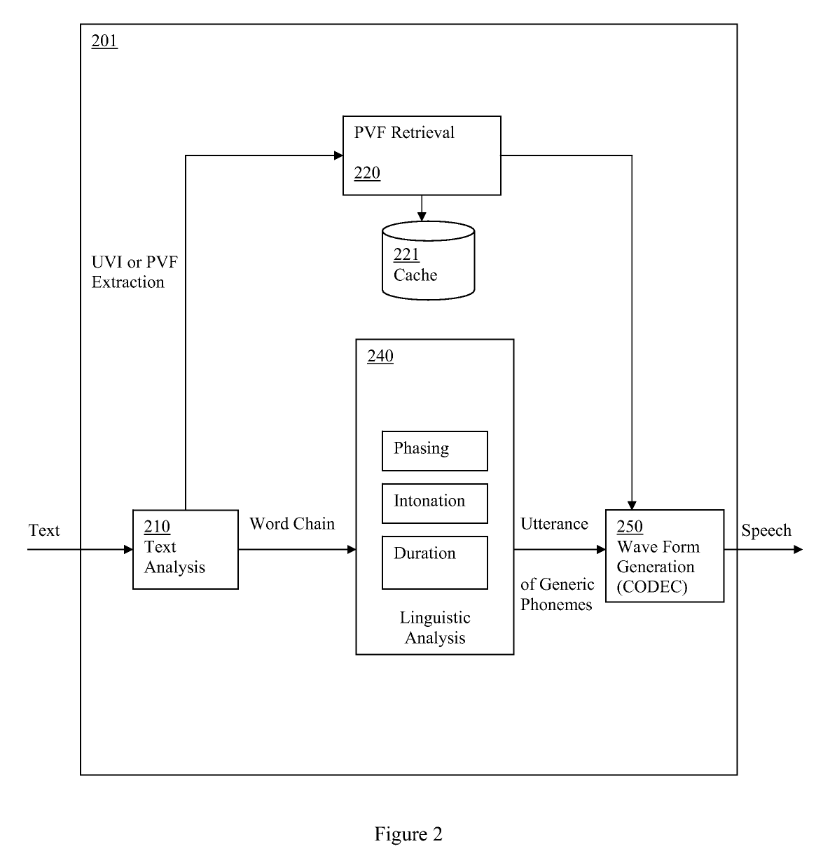

FIG. 2 shows a computer system 201 that represents an example of how an application uses a PVF to read out text. The text of a written computerized document is analyzed in system 210. A first element of this analysis is the extraction from the document of the UVI or of the PVF if the PVF is transported directly in the document. The Text Analysis 210 notifies the PVF retrieval system 220. If the notification contains the actual PVF, the PVF retrieval system 220 simply imports the PVF. If the notification content is a UVI, the PVF retrieval system 220 takes the role of the PVF Consumer 140 described in FIG. 1. In both cases, the PVF can optionally be stored locally, in a Cache 221 or other storage device, for subsequent use. In addition to communicating the UVI or PVF to the PVF retrieval system 220, the text analysis system 210 sends the text to be read out as a chain of words to the Linguistic analysis system 240 which transforms the incoming chain of words into an outgoing utterance of generic phonemes. This can be achieved using any now known or later developed technology. The Linguistic analysis system 240 sends the utterance of generic phonemes to a Wave form generation (WFG) system 250. The Linguistic analysis system determines the phrasing, intonation and duration of the chain of words. The WFG system 250 uses the voice pattern characteristics and CODEC reference specified in the PVF received from the PVF retrieval system 220 to generate the speech corresponding to the received text document. The speech is personalized with the voice associated with the particular PVF used. The speech output can be played directly using an audio device or saved into a media file, or both.

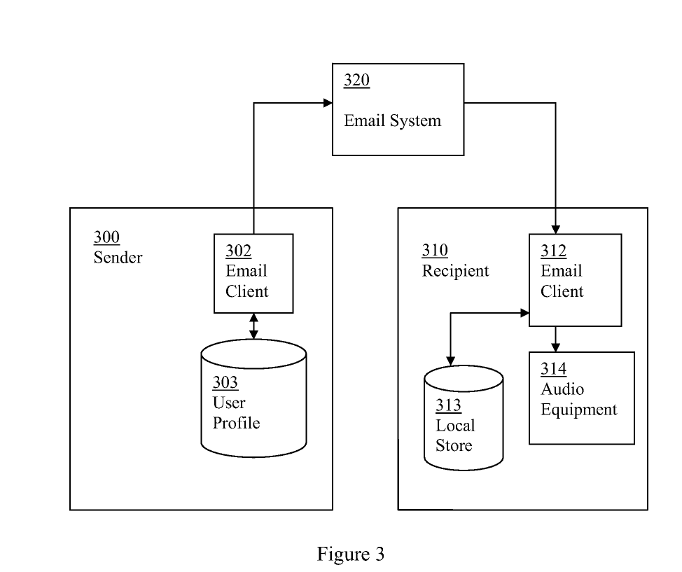

FIG. 3 is a schematic of an illustrative embodiment of the present invention in operation. It shows one example use case made possible by the present invention. Many other use cases are supported with variations of the mechanisms described in the example. A Sending Party 300 uses his or her Email client 302 to send an email to Recipient 310 over an Email system 320 and the Recipient's Email client 312. After receipt by email client 312, the Recipient 310 listens to the Email in speech form over his or her Audio equipment 314. The speech output is performed with the voice of the Sender 300.

The Sender or Sending party 300 can include personal voice information in the communication. This can be done in one of several ways including: manually, whereby Sender 300 communicates informally the UVI reference or PVF object to Recipient 310 within or outside of the channel constituted by the email being sent; semi-automatically whereby Sender 300 manually enters the UVI reference or the PVF object using an interface of the Email client 302 and the Email client integrates the UVI reference or the PVF object into the email using a formalized format; or automatically whereby the Email client 302 automatically accesses a User profile 303 to retrieve the UVI reference or the PVF object and integrates the UVI reference or the PVF object into the email using a formalized format.

The manual method can have particular value in cases where the size of the document being sent is constrained, for example with Short Messaging Service (SMS). For the semi-automatic and automatic cases, in a preferred embodiment, an open standard is used for formalizing the format of the integration of the UVI reference or the PVF object into the email document. Some applications may not support a standards based mechanism to communicate a UVI or transport a PVF and would then require a proprietary adaptation. An example of a standard that can be leveraged is provided by the Multipurpose Internet Mail Extensions (MIME) as defined by the Internet Engineering Task Force (IETF) in a series of Request For Comment (RFC) documents including RFC 2045, RFC 2046, RFC 2047, RFC 4288, RFC 4289, RFC 2077. MIME is used to transport non-text data in text protocols (such as e-mail, Instant Messaging, etc.). A set of MIME headers has been specified in the standards including: MIME-Version, the presence of this header indicates that the message is MIME formatted; Content-Type, this header indicates the media type of the message content, including a type and subtype, for example: text/plain, audio/basic; Content-Transfer-Encoding, when binary data needs to be transported in text format, it specifies the encoding used. In an embodiment of this invention based on MIME, new type/subtype combinations would have to be created to characterize that a UVI reference or a PVF object is being transported.

The Recipient or Receiving party 310 can receive and use the UVI reference or PVF object. Again various methods can be used, including: manual whereby Recipient 310 launches the read out of the received text through the Audio equipment 314 and manually enters a UVI reference or a PVF object location using functions built in the Email client 312 or using an application independent of the Email client; automatic out-of-band whereby no UVI reference or PVF object is transported within the email document but the Local store 313 of the Receiving party 310 contains a UVI reference or a PVF object, for example as part of a personal address book, that can be automatically associated with the Sender 301; or automatic in-band whereby Email client 312 automatically extracts the UVI reference or the PVF object when one of those entities is transported in a formalized format within the email document. The manual method can be of particular value in cases where the Recipient 310 wants to hear the text read out with a voice different from the voice of the Sender 301.

As we have seen above in the description, the PVF object can be stored in various places including: Local store 313 of Receiving party 310 (see FIG. 3); PVF Retrieval system 220 including its Cache 221 (see FIG. 2); Networked PVF store 130 (see FIG. 1). In cases other than Local store 313, the PVF is retrieved by submitting a UVI as the key.

There are multiple options for implementing the PVF store 130 (see FIG. 1). A single central database is one example. A distributed model with one database per country, per region, per city is a second example. The system could be under public or private ownership or any combination.

The PVF of a person is personal in nature. It is therefore expected that an embodiment of the present invention would integrate security techniques available today to enforce privacy protection where it is desired. The owner of a PVF would also own the responsibility to manage the authorization rights for systems or people to access his or her PVF.

It is understood that a computer system may be implemented as any type of computing infrastructure. A computer system generally includes a processor, input/output (I/O), memory, and at least one bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. A bus provides a communication link between each of the components in the computer system and likewise may comprise any known type of transmission link, including electrical, optical, wireless, etc. Although not shown, additional components, such as cache memory, communication systems, system software, etc., may be incorporated into a computer system. Local storage may comprise any type of read write memory, such as a disk drive, optical storage, USB key, memory card, flash drive, etc.

Access to a computer system and network resources may be provided over a network such as the Internet, a local area network (LAN), a wide area network (WAN), a virtual private network (VPN), wireless, cellular, etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising an on demand application manager could be created, maintained and/or deployed by a service provider that offers the functions described herein for customers. That is, a service provider could offer to deploy or provide application management as described above.

It is understood that in addition to being implemented as a system and method, the features may be provided as a program product stored on a computer-readable medium. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

The invention has been described in detail with particular reference to certain preferred embodiments thereof, but it will be understood that variations and modifications can be effected within the spirit and scope of the invention.

What is claimed is:

1. A storage and delivery system for text-to-speech files comprising:
system for storing a plurality of voice fonts wherein each voice font has associated therewith a universal voice identifier (UVI);
system for retrieving a voice font by a receiver of a message containing text, wherein the message contains the UVI and the receiver requests the voice font associated with the UVI from the means for storing; and
system for converting text to speech using the voice font associated with the UVI.

2. The storage and delivery system according to claim 1, wherein the message comprises an email or a text message.

3. The storage and delivery system according to claim 1, wherein the UVI is generated by a voice naming service.

4. The storage and delivery system according to claim 1, the system for storing comprises a central database.

5. The storage and delivery system according to claim 1, wherein the system for storing comprises a memory cache.

6. The storage and delivery system according to claim 1, wherein storage of a voice font associated with a UVI requires a fee.

7. The storage and delivery system according to claim 1, wherein the voice fonts are embodied in a data structure that associates basic phonetic units with corresponding speech segments.

8. A method for converting text to speech comprising:
storing a plurality of voice fonts wherein each voice font has associated therewith a universal voice identifier (UVI);
retrieving a voice font by a receiver of a message containing text wherein the message contains the UVI;
converting text to speech of the message using the voice font associated with the UVI.

9. The method according to claim 8, wherein the voice font is embodied in a data structure that associates basic phonetic units with corresponding speech segments.

10. The method according to claim 8, further comprising retrieving a text-to-speech (TTS) engine by the receiver, the TTS engine being operable to synthesize the speech based on the voice font.

11. The method according to claim 8, wherein retrieving comprises obtaining the voice font from a central database.

12. The method according to claim 8, wherein the message comprises an email or a text message.

13. The method according to claim 8, wherein the plurality of voice fonts are embodied in a data structure that associates basic phonetic units with corresponding speech segments.

14. A computer-readable medium having computer-executable instructions that, when executed, cause a computer to perform a process comprising:
storing a plurality of voice fonts wherein each voice font has associated therewith a universal voice identifier (UVI);
retrieving a voice font by a receiver of a message containing text wherein the message contains the UVI; and
converting text to speech of the message using the voice font associated with the UVI.

15. The computer-readable medium according to claim 14, wherein the message comprises an email or a text message.

16. The computer-readable medium according to claim 14, wherein retrieving the voice font comprises obtaining the voice from a central database.

17. A method for for deploying a system for converting text to speech comprising:
providing a computer infrastructure being operable to:
store a plurality of voice fonts wherein each voice font has associated therewith a universal voice identifier (UVI);
retrieve a voice font by a receiver of a message containing text wherein the message contains the UVI; and
convert text to speech of the message using the voice font associated with the UVI.

18. The method according to claim 17, wherein the voice font is embodied in a data structure that associates basic phonetic units with corresponding speech segments.

19. The method according to claim 17, wherein the message comprises an email or a text message.

20. The method according to claim 17, wherein the voice font is stored in a central database.
